(19) United States
(12) Patent Application Publication
(10) Pub. No.: US 2010/0100618 A1
(43) Pub. Date: Apr. 22, 2010

(54) Differentiating a User from Multiple Users Based on a Determined Pattern of Network Usage

(76) Inventors: Matthew KUHLKE, San Francisco, CA (US); Alan Darryl Gatzke, Bainbridge Island, WA (US); John Toebes, Cary, NC (US); Guido Jouret, Mountain View, CA (US); Philip Clifford Jacobs, Windham, NH (US)

Correspondence Address: LEON R TURKEVICH, 2000 M STREET NW, 7TH FLOOR, WASHINGTON, DC, 200363307, US

(21) Appl. No.: 12/256,000

(22) Filed: Oct. 22, 2008

(51) Int. Cl. G06F 15/16

(52) U.S. Cl. 709/224

(57) ABSTRACT

In one embodiment, a method comprises detecting, by an apparatus, first network activity within a time interval on at least a first user device at a user premises, the first user device usable by first and second users; determining from the first network activity a first pattern of network usage associated with the first user and a second pattern of network usage associated with the second user, the second pattern distinct from the first pattern; detecting, by the apparatus, second network activity on the first user device at the user premises following the time interval; and selectively identifying the second network activity as performed by the first user based on a determined correlation between the second network activity and the first pattern of network usage.

### TECHNICAL FIELD

The present disclosure generally relates to distinguishing a user from among multiple users that share a user device at a user premises, for example a personal computer.

### BACKGROUND

Individuals are accustomed to sharing a limited resource at a user premises, for example a personal computer, a remote control of a television, a cable set-top box, etc.. Individuals can establish personalized settings on a shared personal computer based on creating a prescribed user identity having an associated user profile within the operating system on the shared personal computer (e.g., Windows XP commercially available from Microsoft Corporation). The user profile is stored in the shared personal computer as a data structure that includes attributes and settings specifically associated with the corresponding user identity. Once an individual has created a user identity, the individual can log into the operating system environment (e.g., an executable instance of the operating system that is stored in computer memory reserved by the operating system) using the corresponding user identity. Once logged into the operating system using his or her user identity, the individual can be identifiable as a “user” based on the corresponding user identity and enjoy personalized user service based on the corresponding user profile that stores personalized settings for various executable applications such as a web browser (e.g., Firefox) (e.g., bookmarks, display settings, security settings, etc.). The user profile for the corresponding user identity also can contain information supplied from external sources, for example websites can store data structures known as “cookies” within the user profile.

Although a personal computer can have multiple user profiles for respective individuals, an individual can enjoy his or her personalized settings only while logged into the operating system environment using his or her corresponding user identity: if a first individual having established a first user identity on the personal computer used the personal computer while the operating system environment presented the user profile of a second user identity assigned to a second individual, the first individual would not have access to the personalized settings established for the first user identity.

### BRIEF DESCRIPTION OF THE DRAWINGS

Reference is made to the attached drawings, wherein elements having the same reference numeral designations represent like elements throughout and wherein:

FIG. 1 illustrates an example system having an apparatus for enabling identification of a user based on a determined correlation between network activity by the user and prior detected network activity, according to an example embodiment.

FIG. 2 illustrates an example apparatus from the system of FIG. 1, according to an example embodiment.

FIGS. 3A-3D illustrate an example method by the apparatus of FIG. 2 for enabling identification of the user, according to an example embodiment.

FIG. 4 illustrates an example sequence of network activity initiated by the users of FIG. 1 and detected by the apparatus of FIGS. 1 and 2, according to an example embodiment.

FIGS. 5A and 5B summarize an example data structure generated by the apparatus of FIGS. 1 and 2 for enabling identification of a user, according to an example embodiment.

### DESCRIPTION OF EXAMPLE EMBODIMENTS OVERVIEW

In one embodiment, a method comprises detecting, by an apparatus, first network activity within a time interval on at least a first user device at a user premises, the first user device usable by at least first and second users and distinct from the apparatus, the apparatus positioned at the user premises; determining by the apparatus from the first network activity a first pattern of network usage associated with the first user and a second pattern of network usage associated with the second user, the second pattern distinct from the first pattern; detecting, by the apparatus, second network activity on the first user device at the user premises following the time interval; and selectively identifying by the apparatus the second network activity as performed by the first user based on a determined correlation between the second network activity and the first pattern of network usage.

In another embodiment, an apparatus comprises a device interface circuit and a processor circuit. The device interface circuit is configured for detecting first network activity within a time interval on at least a first user device at a user premises. The first user device is usable by at least first and second users and is distinct from the apparatus. The apparatus is positioned at the user premises. The processor circuit is configured for determining from the first network activity a first pattern of network usage associated with the first user and a second pattern of network usage associated with the second user, the second pattern distinct from the first pattern. The device interface circuit further is configured for detecting second network activity on the first user device at the user premises following the time interval. The processor circuit further is configured for selectively identifying the second network activity as performed by the first user based on a determined correlation between the second network activity and the first pattern of network usage.

In another embodiment, method comprises detecting, by an apparatus, first network activity within a time interval on at least a first user device at a user premises, the first user device usable by at least first and second users and distinct from the apparatus, the apparatus positioned at the user premises; determining by the apparatus from the first network activity a first pattern of network usage associated with the first user and a second pattern of network usage associated with the second user, the second pattern distinct from the first pattern; detecting, by the apparatus, second network activity on a second user device at the user premises following the time interval; and selectively identifying by the apparatus the second network activity as performed by the first user based on a determined correlation between the second network activity and the first pattern of network usage.

In yet another embodiment, an apparatus comprises a device interface circuit and a processor circuit. The device interface circuit is configured for detecting first network activity within a time interval on at least a first user device at a user premises. The first user device is usable by at least first and second users and distinct from the apparatus. The apparatus is positioned at the user premises. The processor circuit is configured for determining from the first network activity a first pattern of network usage associated with the first user and a second pattern of network usage associated with the second user, the second pattern distinct from the first pattern. The device interface circuit further is configured for detecting second network activity on a second user device at the user premises following the time interval. The processor circuit further is configured for selectively identifying the second network activity as performed by the first user based on a determined correlation between the second network activity and the first pattern of network usage.

### DETAILED DESCRIPTION

Particular embodiments disclosed herein enable an apparatus at a user premises to distinguish between users that are interacting with a shared user device during respective user access sessions without the necessity of the users logging in or otherwise identifying themselves, based on a determined correlation between a first pattern of network usage (detected by the apparatus during a “training” interval) and second network activity that is detected by the apparatus after the training interval. In particular, each user of a shared user device (e.g., a personal computer or a remote control for a digital television set) can supply inputs to the shared user device while the user has possession or control of the shared user device (e.g., based on mutual agreement among users or availability of the user device, etc.). The user input supplied by a user to the shared user device can be detected by an apparatus either directly (e.g., if the shared user device forwards to the apparatus the user input or a command responsive to the user input) or indirectly (e.g., if the shared device sends a message to the apparatus notifying of specific network activity requested by the user). Consequently, the apparatus can store in a tangible computer readable memory a data structure that identifies a first pattern of the network usage (e.g., a sequence of user inputs or a sequence of network activity such as requested media streams) during the user access session.

A shared user device typically will have a period of inactivity between a first time interval when the shared user device is in use by one user, and a second time interval when the shared user device is in use by another user. Hence, if the apparatus detects additional inputs following a detected idle interval relative to the identified sequence of inputs already stored in the data structure, the apparatus can determine and identify that the additional inputs constitute the beginning of a new user access session, and update the data structure to identify a second pattern of the network usage during the new user access session. User access sessions can be distinguished not only based on a detected idle interval for a shared user device, but also based on detected inputs supplied via distinct user input devices.

Individuals that use electronic devices such as remote controls for television sets or set-top boxes, personal computers, etc., tend to form repeatable patterns (i.e., habits) with respect to content they wish to consume on the electronic devices. Hence, the storage of the first pattern of network usage in the data structure enables the apparatus to determine whether inputs supplied by a user during a subsequent user access session has a correlation to the first pattern stored in the data structure. If the first pattern of network usage and the second pattern of the network usage have a determined correlation (e.g., based on pattern matching, time of day similarity, day of week similarity, duration of access session similarly, etc.), the apparatus can conclude that the respective first and second user access session were performed by the same user. If the first and second patterns do not have a determined correlation, the apparatus can conclude the respective first and second user access sessions were performed by respective first and second users.

Hence, following identification of first and second user access sessions performed by respective first and second users, the apparatus can determine from a subsequent determined user access session whether the corresponding detected network activity demonstrates a pattern of network usage that correlates with one of the stored patterns of network usage associated with a corresponding user, or whether the detected network activity represents a new user based on a determined absence of any correlation with any stored patterns. Consequently, a detected correlation enables identification that the current network activity is performed by one of the identified users based on the determined correlation between the current network activity and the stored patterns of network usage.

The identification of network activity performed by a previously identified user can be applied for various shared user devices, including shared televisions or video set-top boxes, shared computers, etc. As described below, the determined pattern of network usage for a given user access session can be identified in various ways, depending on the shared user device. For example, for a shared remote control device controlling the apparatus (implemented, for example as an intelligent set top box), a pattern of network usage can be determined as a sequence of video navigation selection commands (e.g., video guide, a prescribed television channel, etc.) or a sequence of addressable video streams or their respective video providers (e.g., Fox news, NBC news, etc.); hence, a user can be identified based on the sequence of television channels (or resulting content) that he or she selects during the corresponding user access session.

In the example of a shared personal computer having a web browser, a user can be identified by the apparatus (implemented, for example as a customer premises Internet Protocol (IP) based network router providing reachability for the shared personal computer to an IP-based wide area network) based on determining the pattern of network usage from the detected network activity implemented as a sequence of websites that are visited by the user during the user access session, including prescribed websites and prescribed search engines. A user also can be identified by the apparatus (implemented, for example, as a network router) based on determining the pattern of network usage from the detected network activity implemented as an identifiable group of network services requested by the user device (e.g., video or audio streams, webpages, e-mail, instant messaging, online games, remote desktop connection, web services such as the “Google Docs” online word processor, etc.), where each network service can be identified by a corresponding transport layer port identifier (e.g., Transmission Control Protocol (TCP) port 80, User Datagram Protocol (UDP) port 220, etc.). Hence, one user can be identified based on determining a corresponding first pattern as including a first subset of the identifiable group of network services (e.g., web services via TCP port 80, POP3 e-mail via TCP port 110, instant messaging (IM) via TCP port 1533), whereas another user can be identified based on determining the corresponding second pattern that includes a second subset of the identifiable group of network services (e.g., remote desktop service via TCP port 3389, IMAP e-mail via UDP port 220, iTunes audio via TCP port 3689, and web services via TCP port 80).

Hence, users of a shared user device can be differentiated by an apparatus based on determining their respective patterns of network usage. The apparatus also can identify and differentiate between users if a user begins to use a second shared user device, based on detecting a matching pattern between network activity detected from the second shared user device relative to the stored patterns of network usage.

The differentiation of users can be used to provide personalized recommendations to the user interacting with the shared user device during the current user access session. For example the apparatus can append a user identifier to a request for network service (e.g., a hypertext transport protocol (HTTP) web request) that is destined for a destination server via a wide area network; the apparatus also can respond to a query from a remote server requesting user differentiation in order to provide user recommendations based on prior user activity (also known as “socially relevant gestures”). An example system that provides recommendations to users based on socially relevant gestures is disclosed in commonly-assigned, copending U.S. patent application Ser. No. 11/947,298, filed Nov. 29, 2007, entitled “Socially Collaborative Filtering”.

The addressable video stream as used herein can be implemented as any digital video stream for a given piece of content (e.g., a video clip, a broadcast television program, an advertisement inserted within a broadcast television program or a DVD menu, etc.). The addressable media stream can be downloaded from a network in the form of streaming media, or retrieved from a local storage medium such as a DVD or a mass storage device such as a hard disk drive or a flash memory (e.g., a 4 GB USB memory card). The term “addressable” as used herein with respect to a media stream refers to a media stream having attributes, for example a time index, that enables identification of a time instance relative to a fixed “point” (i.e., location or position) within the media stream. Hence, an addressable media stream can present a sequence of events that is deterministic and repeatable.

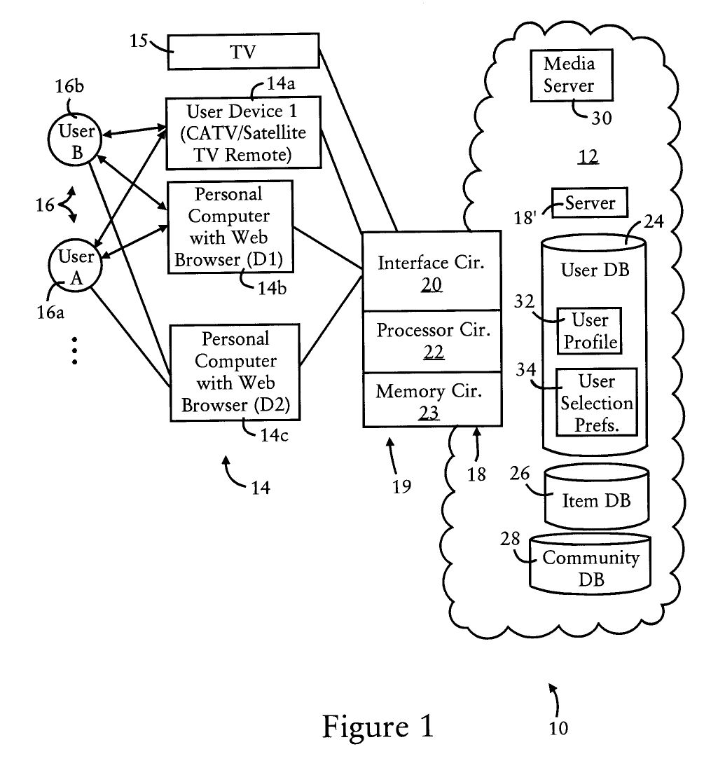

FIG. 1 illustrates an example system 10 having an apparatus 18 for distinguishing between users 16 (e.g., 16a or 16b) that use shared user devices 14, according to an example embodiment. The system 10 includes an apparatus 18, also referred to as a “server”, configured for detecting network activity by one of the users 16 on a given user device 14 at a user premises 19. Example shared user devices 14 can include a remote control 14a for an intelligent digital television system 15 at the user premises 19, a personal computer (“D1”) 14b or (“D2”) 14c each having a web browser, an IP based telephone 14c (for example, a Voice over IP telephone), a web enabled cell phone (not shown), and/or a wired or wireless game console 14e (not shown), etc.

According to example embodiments, the apparatus 18 can detect network activity within a training time interval on a first shared user device (e.g., 14b) at the user premises, where the first user device is usable by at least the users 16a and 16b. During the training time interval the apparatus 18 can detect a first user access session (a first portion of the training time interval) during which time a first of the users (e.g., 16a) can be supplying inputs to the first shared user device (e.g., 14b) according to a first pattern of network usage that can be determined by the apparatus 18. The apparatus 18 can store the determined first pattern of network usage associated with the first user access session.

After a detected idle interval, the apparatus 18 also can detect a second user access session (a second portion of the training time interval) during which time either the first user (e.g., 16a) or the second user (e.g., 16b) might be supplying inputs to the first shared user device (e.g., 14b) according to a second pattern of network usage that can be determined by the apparatus 18. The apparatus 18 can store the determined second pattern of network usage according with the second user access session. Hence, the apparatus 18 can store, for each user access session, the corresponding pattern of network usage based on the network activity detected by the apparatus 18. Alternately, the apparatus 18 can detect that the respective first and second user access sessions can occur concurrently via respective distinct input devices (e.g., 14b and 14c); hence the first pattern of network usage and the second pattern of network usage can be distinguishable based on the respective input devices (e.g., 14b and 14c).

As described previously, since individuals tend to form repeatable patterns with respect to content they wish to consume on user devices 14, the apparatus 18 can selectively identify whether the user interacting with the first shared user device (e.g., 14b) during the first user access session is the same individual as the user interacting with the first shared user device (e.g., 14b) during the second user access session, based on whether the first pattern of network usage generated during the first user access session has a determined correlation with the second pattern of network usage generated during the second user access session: if there is no correlation, the second pattern of network usage can be identified by the apparatus 18 as originating from another user (e.g., 16b).

Hence, assuming the apparatus 18 detects a third user access session following a determined idle interval after the second user access session, the apparatus 18 can selectively identify the network activity is performed by the first user (e.g., 16a) based on a determined correlation between the network activity detected during the third user access session, and the first pattern of network usage generated during the first user access session and stored in a data structure by the apparatus 18.

Hence, the identification of network activity as performed by a given user can be forwarded to a prescribed destination, for example the server 18′, that can collect expressions of user selections toward content assets as socially relevant gestures identifying user preferences relative to network assets that are available in the wide area network 12. For example, information about a preference toward a given content asset by a given user (identified, for example by an IP address, user alias, etc.) can be stored in an item database 26 for storage of statistical information enabling marketing and advertising analysis, etc., in order to identify items that are favored by different users based on various user characteristics, described in further detail in the above-identified U.S. patent application Ser. No. 11/947,298. The server 18′ also can update a user profile 32 and/or user selection preferences 34 stored in a user database 24. Hence, the updated user selection preferences 34 can be used for identifying recommended content for a given user, as described in the above-identified U.S. patent application Ser. No. 11/947,298. The socially relevant gestures also can be used by the server 18′ to populate other databases, for example a community database 28 associated with social networking sites.

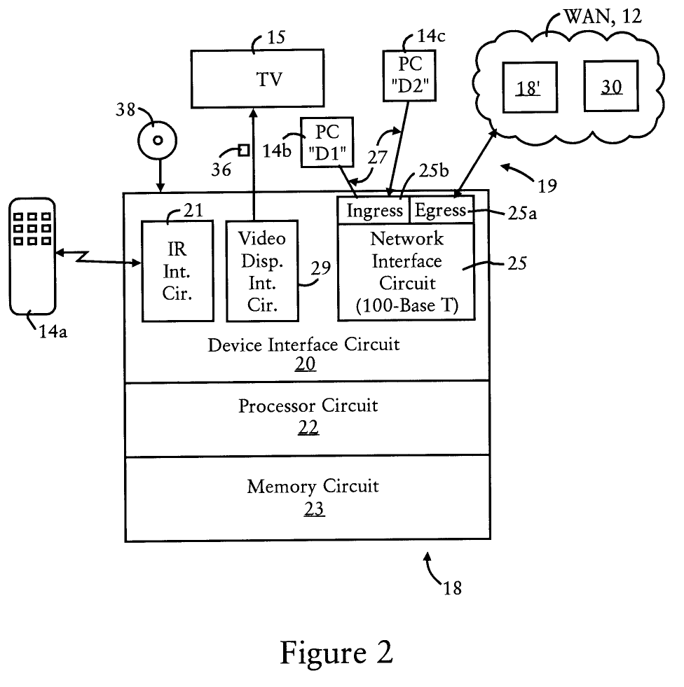

FIG. 2 illustrates an example apparatus 18 from the system of FIG. 1 and configured for identifying a user during a user access session based on determined patterns of network usage, according to an example embodiment. The apparatus 18 installed at the user premises (i.e., customer premises) 19 can be implemented in numerous forms, for example a consumer set-top box configured for supplying a media stream 36 to a consumer television 15; the apparatus 18 also can be implemented as a user premises network router, for example a commercially-available Linksys® network router; the apparatus 18 also can be implemented as a user premises device that integrates operations of a consumer set-top box and a commercially available user premises network router, for example the commercially available Apple TV from Apple, Inc., Cupertino Calif., or the Netflix Player™ by Roku, Inc., Saratoga, Calif., which can be modified as described herein.

The apparatus 18 also can be implemented as an integrated device that includes a user device (e.g., a user input device such as a keyboard, touchscreen, etc.) and circuitry for detecting network activity on the user device within the apparatus 18. For example, the apparatus 18 can be implemented as a personal computer that can detect network activity by a user input device (e.g., integrated keyboard or touchscreen) within the personal computer or coupled to the personal computer (e.g., via a Universal Serial Bus (USB) port). Hence, the apparatus 18, implemented for example as a personal computer, can identify the user of the personal computer based on detecting the network activity initiated by the user via the integrated keyboard or touchscreen; the apparatus 18 also can identify the user of another personal computer 14c based on detecting the network activity on the personal computer 14c.

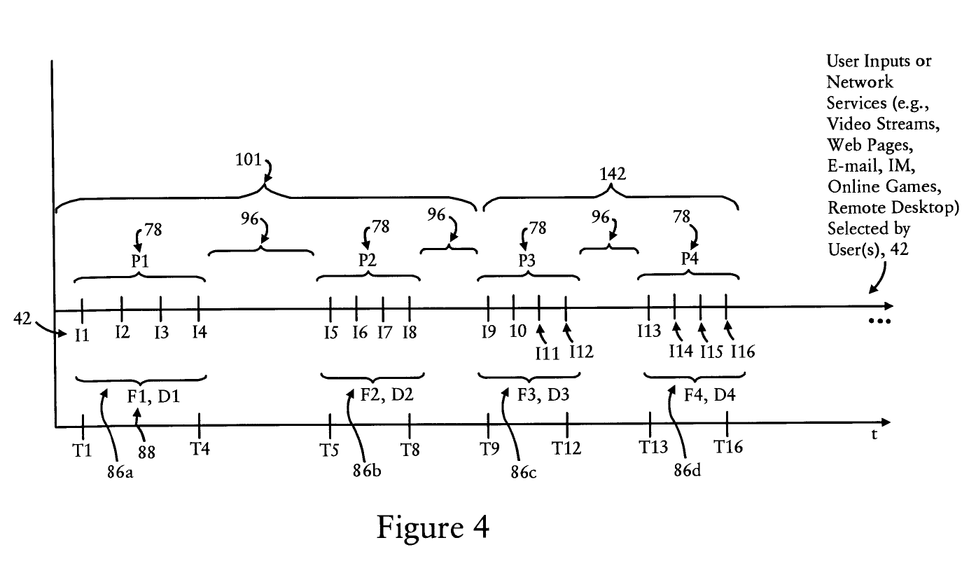

The apparatus 18 includes a device interface circuit 20, a processor circuit 22, and a memory circuit 23. The device interface circuit 20 is configured for detecting network activity on a user device 14 (e.g., 14a, 14b and/or 14c) at the user premises 19. The device interface circuit 20 also is configured for forwarding all detected network activity (e.g., user inputs, responses received from the wide area network 12, etc.) to the processor circuit 22 for analysis. As described below with respect to FIG. 4, the device interface circuit 20 can be configured for detecting network activity from different user devices 14 at different time intervals identified by the processor circuit 22.

The device interface circuit 20 can include a network interface circuit 25 (implemented for example as a 100 Mb per second Ethernet or 100-Base T interface circuit, a cable modem, and/or a wireless IEEE 802.11 transceiver) having at least an egress port 25a (e.g., a 100-Base T interface, a cable modem interface, and/or a wireless IEEE 802.11 transceiver) for sending and receiving data to and from a wide area network 12, for example a content provider network having access to the Internet.

The device interface circuit 20 also can include different interface circuitry depending on implementation (e.g., a commercially available user premises network router and/or a set-top box) in order to detect network activity including user inputs and/or data received from the wide area network 12 and destined for a user device 14 or the television 15. For example, if the apparatus 18 is implemented as a user premises network router, the network interface circuit 25 also can include an ingress port 25b configured for establishing wired or wireless links 27 with user devices 14 (e.g., a personal computer 14b and/or a game console). As described below, the apparatus 18 implemented as a user premises network router can identify any data 36 that is presented to the user 16. Example network data 36 received from the network 12 and that can be identified by the apparatus 18 can include an addressable video stream supplied by a media server 30, metadata describing the corresponding addressable video stream (e.g., a video provider identifier specifying a video provider that supplies the corresponding addressable via stream, a channel guide identifier identifying the addressable video stream as a prescribed video channel guide), web content (e.g., webpages) and associated metadata describing the web content, network data associated with an identifiable group of network services (e.g., video streams, audio streams, webpages, e-mail, instant messaging, online games, remote desktop connections, etc.) that can be identifiable by a corresponding transport layer port identifier

If the apparatus 18 is configured for providing set-top box functionality, the device interface circuit 20 can include an infrared interface circuit 21 configured for receiving user selection inputs from a remote control 14a, and a video display interface circuit 29 configured for supplying video display signals to the television 15. The device interface circuit 20 also can include disc player circuitry that enables retrieval of the addressable video stream 36 from a DVD 38, or a data link interface that can communicate with an external DVD player. The device interface circuit 20 also can include internal interface circuitry in the event that the user device is implemented within the apparatus 18, for example where the user device is implemented as a user input device (e.g., keyboard or touchscreen) integrated within the apparatus (e.g., a personal computer) 18.

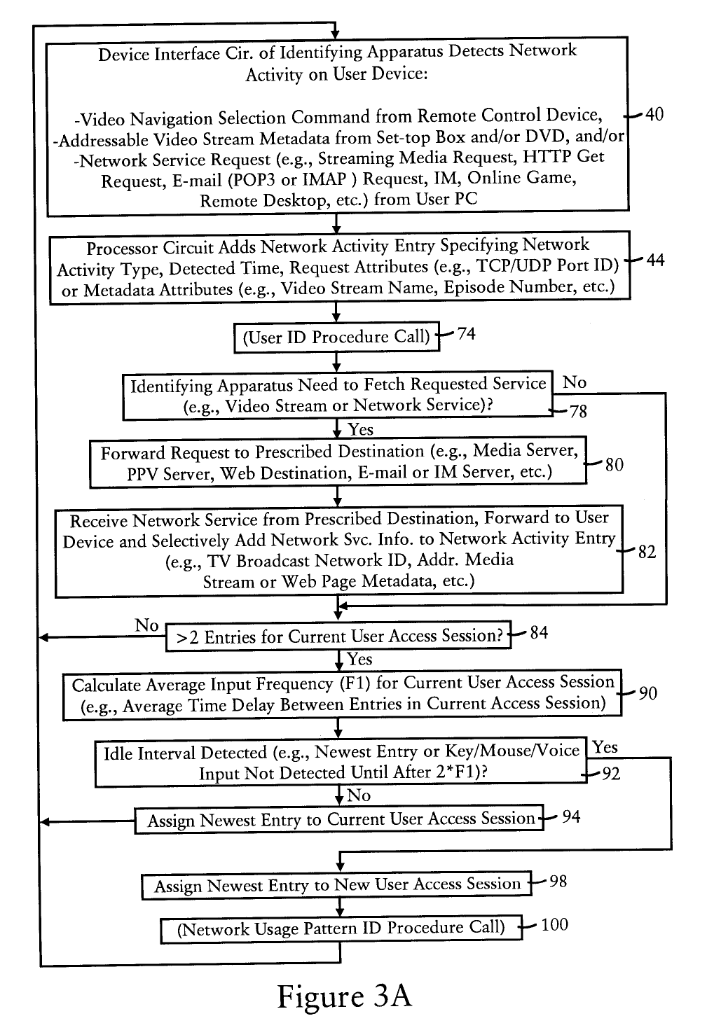

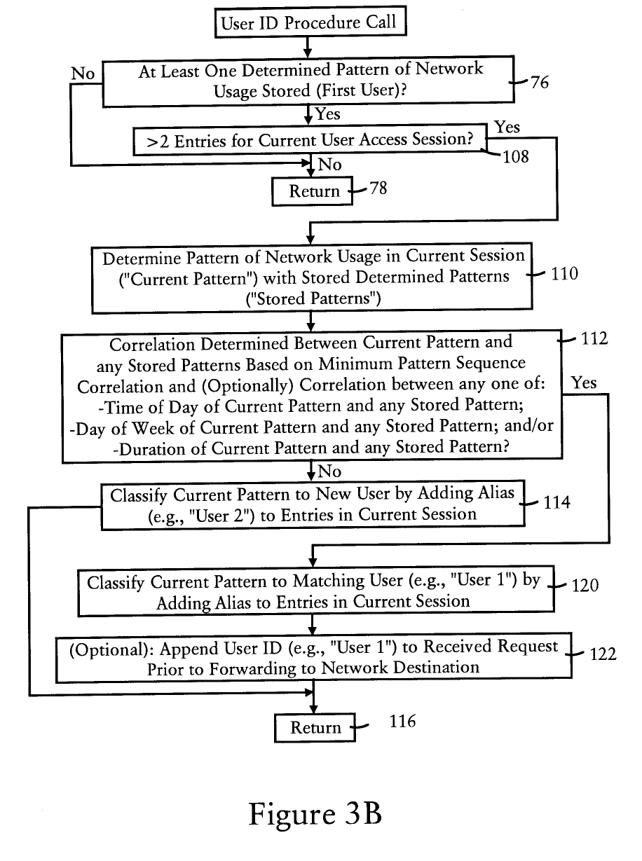

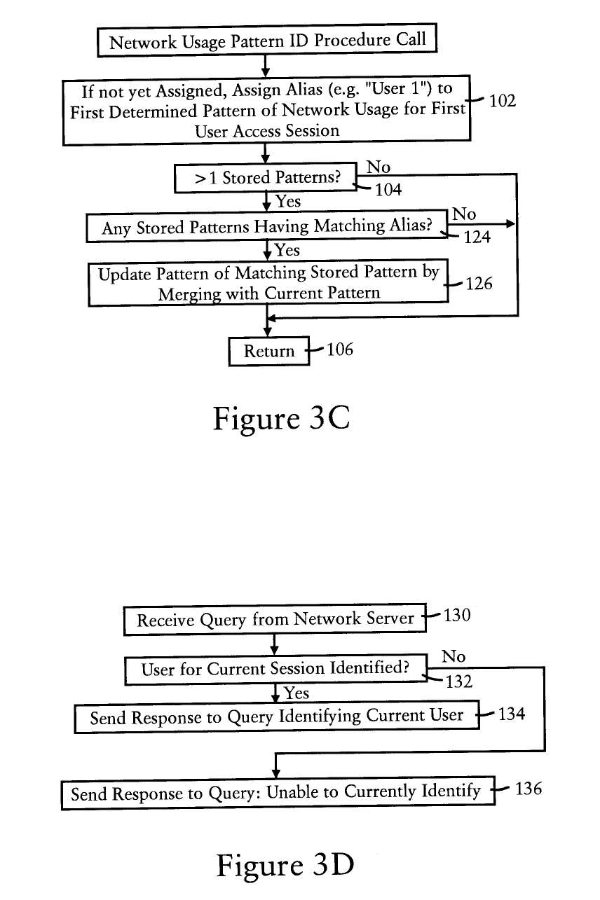

The processor circuit 22 is configured for determining patterns of network usage from the network activity detected by the device interface circuit 20, including identifying distinct user access sessions, determining for each user access session a corresponding pattern of network usage based on the detected network activity within the corresponding user access session, storing the corresponding pattern of network usage in a data structure stored in the memory circuit 23, and selectively identifying subsequent network activity as performed by a previously-identified user based on a determined correlation between the subsequent network activity and the corresponding stored pattern of network usage. Additional details regarding the configuration of the processor circuit 22 are described in further detail below with respect to FIGS. 3-5.

Any of the disclosed circuits of the apparatus 18 (including the device interface circuit 20, the processor circuit 22, the memory circuit 23, and their associated components) can be implemented in multiple forms. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a microprocessor circuit (not shown), where execution of executable code stored in an internal memory circuit (e.g., within the memory circuit 23) causes the processor circuit to store application state variables in processor memory, creating an executable application resource (e.g., an application instance) that performs the operations of the circuit as described herein. Hence, use of the term “circuit” in this specification refers to both a hardware-based circuit that includes logic for performing the described operations, or a software-based circuit that includes a reserved portion of processor memory for storage of application state data and application variables that are modified by execution of the executable code by a processor circuit. The memory circuit 23 can be implemented, for example, using a non-volatile memory such as a programmable read only memory (PROM) or an EPROM, and/or a volatile memory such as a DRAM, etc.

Further, any reference to “outputting a data structure” (or the like) can be implemented based on storing that data structure in a tangible memory medium in the disclosed apparatus (e.g., in the memory circuit 23 or a transmit buffer in the network interface circuit 25). Any reference to “outputting a data structure” (or the like) also can include electrically transmitting (e.g., via wired electric current or wireless electric field, as appropriate) the data structure stored in the tangible memory medium to another network node via a communications medium (e.g., a wired or wireless link, as appropriate) (optical transmission also can be used, as appropriate). Similarly, any reference to “receiving a data structure” (or the like) can be implemented based on the disclosed apparatus detecting the electrical (or optical) transmission of the data structure on the communications medium, and storing the detected transmission of the data structure in a tangible memory medium in the disclosed apparatus (e.g., in a receive buffer). Also note that the memory circuit 23 can be implemented dynamically by the processor circuit 22, for example based on memory address assignment and partitioning executed by the processor circuit 22.

FIGS. 3A, 3B, 3C and 3D illustrate an example method by the apparatus 18 of FIGS. 1 and 2, according to an example embodiment. The steps described in FIGS. 3A-3D can be implemented as executable code stored on a computer readable storage medium (e.g., floppy disk, hard disk, ROM, EEPROM, nonvolatile RAM, CD-ROM, etc.) that are completed based on execution of the code by a processor circuit; the steps described herein also can be implemented as executable logic that is encoded in one or more tangible media for execution (e.g., programmable logic arrays or devices, field programmable gate arrays, programmable array logic, application specific integrated circuits, etc.).

As illustrated in FIG. 3A, the device interface circuit 20 of the identifying apparatus 18 can identify in step 40 network activity (illustrated in FIG. 4 as inputs I1, I2, . . . I16) 42 that occurs on one or more user devices 14. For example, the infrared interface circuit 21 of the device interface circuit 20 can be configured directly receiving commands from a remote control 14a (e.g., video navigation selection commands or volume commands), and forwarding the received remote control commands to the processor circuit 22 for interpretation and analysis. The network interface circuit 25 of the device interface circuit 20 also can receive the network activity 42 in the form of addressable video stream metadata from an external device, for example a set-top box or DVD player that is distinct from the apparatus 18. The network interface circuit 25 of the device interface circuit 20 also detect network activity based on receiving network service requests from a shared user device (e.g., 14b) for a prescribed network service available via the network 12 and having prescribed transport layer port identifiers, or based on receiving from the network 12 the associated responses to the requests initiated from the shared user device. The prescribed transport layer port identifiers (e.g., TCP or UDP port identifiers) are established by the Internet Assigned Numbers Authority (IANA).

Hence, network activity associated with a given user device (e.g., 14b) can be detected in step 40 based on the device interface circuit 20 detecting the request initiated by the user (e.g., 16a) via the user device (e.g., 14b), based on detecting the resulting service provided to the user (e.g., 16a) in response to the request (e.g., a web page, audio stream, video stream, messaging service, etc. provided by a media server 30), or based on detecting an addressable video stream supplied from a local source such as a DVD 38 for a locally available hard disk (e.g., a recorded video program).

As illustrated in FIG. 4, the device interface circuit 20 can detect numerous network activity 42 over time (t): the network activity can be expressed either as a user input from a user device 14, or data supplied to the user device 14 in response to the user input. In addition, the network activity 42 can be supplied by either a single device 14 (e.g., 14a), or multiple shared user devices (e.g., 14a, 14b, and/or 14c). Hence, the device interface circuit 20 can detect the network activity for any one of the user devices 14 at the user premises 19, enabling the processor circuit to identify whether a recognized user is using a different user device 14, described below.

The processor circuit 22 in step 44 responds to the first detected network activity 42 (illustrated in FIG. 4 as the network activity input “I1”) by adding a network activity entry 46 to a newly created data structure 48 configured for storing the detection of the network activity 42 and associated attributes.

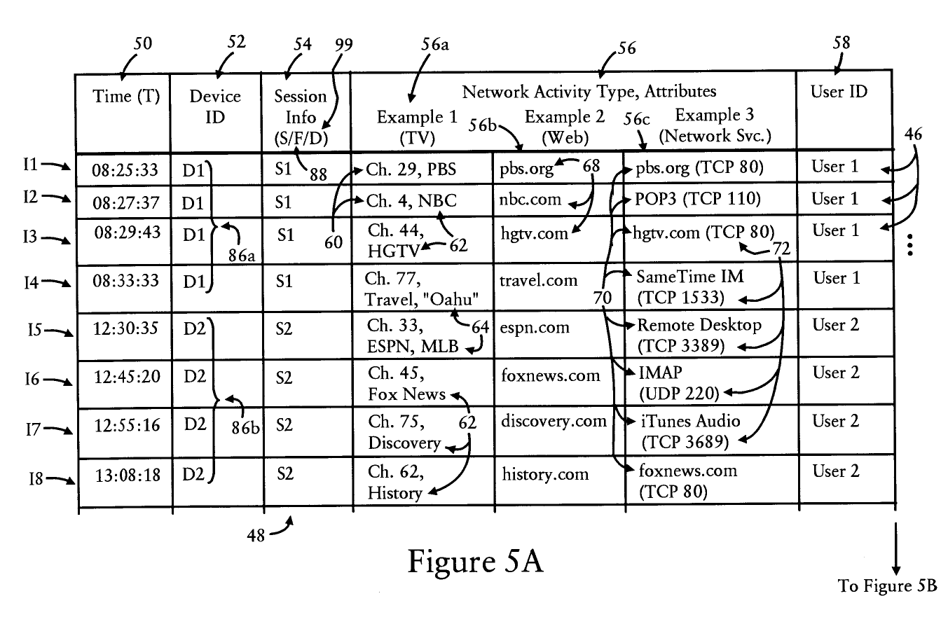

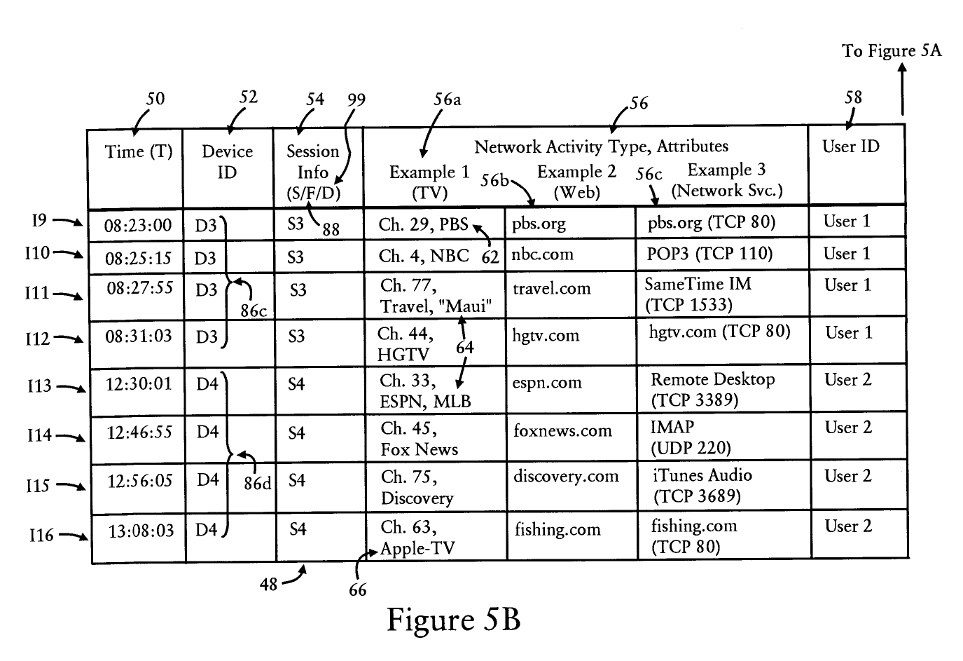

FIGS. 5A and 5B summarize an example data structure 48 created by the processor circuit 22 and stored for example in the memory circuit 23. The data structure illustrated in FIGS. 5A and 5B represents the completion of numerous operations described with respect to FIGS. 3A through 3D, including the detection and processing of the network activity inputs “I1” through “I16”. The data structure 48, however, will be referred to with respect to describing the sequential detection and processing of the network activity inputs “I1” through “I16”. FIG. 5A illustrates the network activity entries 46 for the network activity inputs “I1” through “I8”, and FIG. 5B illustrates the network activity entries 46 for the network activity inputs “I9” through “I16”.

As illustrated with respect to the first network activity entry 46 for the detected network activity “I1” 42, the processor circuit 22 can add in step 44: a corresponding time value (T) 50 specifying the 24-hour format time (plus date or day of week, as appropriate) that the corresponding network activity “I1” was detected; a device identifier 52 identifying the user device 14 that is generating or receiving the corresponding network activity “I1”; a session information field 54 specifying attributes regarding the current user access session (e.g., session identifier (S)); and a network activity type field 56 that identifies the specific network activity and associated attributes, described below. Additional parameters related to the session information field 54 (e.g., average input frequency (F) 88, and/or session duration (D) 99) can be added by the processor circuit 22 after having compared multiple network activity entries 46, described below.

Although the data structure 48 also illustrates a user identifier field 58, the processor circuit does not update the user identifier field 58 until identification of the user as described below with respect to step 120 of FIG. 3B.

The processor circuit 22 adds to the network activity type and attributes field 56 based on the type of network activity that is detected. Three examples of network activity are illustrated in FIGS. 5A and 5B as different types of network activity that can be detected and interpreted by the processor circuit 22.

A first example 56a of the network activity type and attributes field 56 specifies video navigation selection commands (e.g., a channel selection) from a user device such as the remote control 14a, and/or an identification of an addressable video stream in the form of a video provider identifier (e.g., “PBS”, “NBC”, “HGTV”, “Fox News”, “Discovery” “History” identifying prescribed cable television broadcast providers) 62, metadata 64 that describes the corresponding addressable video stream (e.g., “MLB” identifying the addressable video stream presentation of “Major League Baseball”, “Oahu” identifying a presentation about tourist travel to Oahu, Hi., and “Maui” identifying a presentation about tourist travel to Maui, Hi.), or a channel guide identifier 66 (e.g., “Apple-TV” for network activity “I16”) that identifies the addressable via the stream as a prescribed video channel guide that enables a user to locate a desired addressable video stream.

Hence, the first example 56a illustrates network activity 42 in the form of user inputs 60 supplied by a user input device 14a directly to the apparatus 18 (implemented as a set-top box) or addressable video streams 36 supplied to the television 15 in response to the user inputs, including selected video channels (e.g., “PBS”, “NBC”, etc.) 62, addressable video stream presentations (e.g., “Major League Baseball”) 64, or channel guides identifiers (e.g., “Apple-TV”) 66 offering prescribed video channel guides for prescribed video services (e.g., Apple-TV, Netflix, Comcast HD, Comcast on demand, etc.). The network activity 42 also can be supplied to the apparatus 18 by a DVD player or separate set-top box that sends messages to the apparatus 18 describing the user selection input and/or the addressable video streams 36 presented to the user. As described below, the processor circuit 22 can determine user patterns from the identifiable sequence of the addressable video streams identified by the video navigation selection command 60, the video provider identifier 62, or the metadata 64 describing the corresponding addressable video stream.

The second example 56b of the network activity type and attributes field 56 specifies web-based requests that can be implemented as HTTP requests specifying respective destination websites that are reachable by the apparatus 18 via an IP-based wide area network 12. For example, the shared personal computers 14b and 14c each have web browsers that can output HTTP requests 68 specifying destination websites based on specified website addresses (e.g., “pbs.org”, “nbc.com”, “hgtv.com”, etc.). The apparatus 18, implemented for example as a network router, can forward the received HTTP requests 68 to the destination websites via the wide area network 12 according to HTTP protocol. As described below, the processor circuit 22 can determine user patterns from the identifiable sequence of the HTTP requests 68 requested by the shared user device.

The third example 56c of the network activity type and attributes field 56 specifies identifiable network services 70 that can be requested by a user device (e.g., 14b or 14c), for example a web-based HTTP service (e.g., “pbs.org”, “hgtv.com”, “foxnews.com” or “fishing.com” as illustrated also with respect to the second example 56b), an e-mail service (e.g., POP3 or IMAP), an instant messaging service (e.g., IBM Sametime™), a streaming audio service (e.g., “iTunes Audio”), or a remote desktop operation (e.g., “Remote Desktop” available commercially from Microsoft Corporation as the “Remote Desktop Connection” (RDC) client executing the “Remote Desktop Protocol”). As illustrated in FIGS. 5A and 5B, each identifiable network service 70 is reachable via the apparatus 18 via the wide area network 12 and has a corresponding transport layer (e.g., TCP or UDP layer) port identifier 72, in accordance with the IANA port number assignments.

Hence, the processor circuit 22 can utilize any one of the examples 56a, 56b, and/or 56c, depending on the user input device 14 in use, in order to detect patterns of network usage by a given user 16.

Referring again to FIG. 3A, the processor circuit 22 adds in step 44 the first network activity entry 46 specifying the network activity type and attributes 56 (e.g., 56a, 56b, or 56c), the detected time 50, and the device identifier 52 (e.g., “D1” for device 14b): the processor circuit 22 also adds the first session identifier “S1” 54 for the first detected network activity “I1” 42. The processor circuit 22 initiates in step 74 a user identification procedure call, illustrated in FIG. 3B.

FIG. 3B illustrates a user identification procedure call executed by the processor circuit 22, according to an example embodiment. The procedure call of FIG. 3B can be executed independently of the steps of FIGS. 3A, 3C, or 3D; Hence, the processor circuit 22 can be configured for independently and concurrently executing the steps of FIGS. 3A, 3B, 3C, and 3D.

Referring to FIG. 3B, the processor circuit 22 determines in step 76 whether at least one determined pattern (e.g., “P1”) 78 of network usage has been stored in the data structure 48 of FIGS. 5A and 5B. At this stage, since the processor circuit 22 has only detected the first network activity “I1”, a determined pattern of network usage (e.g., “P1”) has not yet been determined, since the processor circuit 22 has not identified completion of the first user access session. Hence, the processor circuit 22 returns in step 78 to the method of FIG. 3A for execution of step 78.

The processor circuit 22 in step 78 determines whether it needs to fetch a requested service, for example in response to directly receiving the user requests (e.g., in the form of a video navigation selection command 60, a web request 68, a request for a network service 70). Assuming the processor circuit 22 determines the corresponding network activity 42 is a direct request for service, the processor circuit 22 forwards the request via the device interface circuit 20 to the prescribed destination in step 80, for example the media server 30, a pay-per-view server 18′, a web destination, an e-mail or instant messaging server, etc. In response to receiving in step 82 the associated network service from a prescribed destination, the processor circuit 22 can forward the data associated with the network service (e.g., an addressable audio or video stream, a webpage, etc.) to the user device 14 and selectively add to the corresponding network activity entry 46 any network service information related to the original request (e.g., television broadcast network identifier 62, addressable video stream metadata 64, webpages metadata, etc.) that can help uniquely identify the service provided to the user 16.

If in step 84 the processor circuit 22 decides there are an insufficient number of network activity entries 46 to detect a pattern 78 for the current user access session 86 (e.g., 86a) illustrated in FIG. 4, the processor circuit 22 waits in step 40 for additional network activity 42 in order to detect a pattern of network usage (e.g., “P1”) 78 during the current user access session (e.g., “86a”). As illustrated with respect to FIGS. 4 and 5, the processor circuit 22 repeats the foregoing steps of FIG. 3A until detection and storage in the data structure 48 of the network activity “I2” and “I3” 42 and the respective values for the device identifier 52, session information 54, and network activity type 56.

The following example assumes for illustration sake that multiple users are using only a single shared device: as described previously, multiple user access sessions with respective patterns of network usage can be identified simultaneously based on multiple users (e.g., 16a, 16b) using respective devices (e.g., 14b, 14c) during overlapping time intervals (e.g., user 16a uses device 14b and user 16b uses device 14c during the time interval 101. Assuming multiple users are using only a single shared device, then following storage in the data structure 48 of the network activity entry 46 associated with the network activity “I3” 42, the processor circuit 22 in step 84 can determine an average input frequency (e.g., “F1”) 88 in step 90 for the current user access session 86 based on the previously stored entries 46 for the detected network activity “I1” and “I2”: the difference in the time entries 50 for the detected network activity “I1” and “I2” is two minutes and four seconds (“F1=02:04”), whereas the difference in the time entries 50 for the detected network activity “I2” and “I3” is two minutes and six seconds (“02:06”).

Hence, the processor circuit 22 determines in step 92 whether an idle interval is detected in the current user access session 86, for example whether the time difference between the newest entry (for network activity “I3”) and the prior entry (“I2”) is greater than twice the determined input frequency “F1” (i.e., the average time delay between the prior entries “I1” and “I2”) 88. Since in this example of the most recent entry the processor circuit 22 detects the network activity “I3” before the prescribed idle interval is established, the processor circuit 22 assigns the newest entry “I3” in step 94 to the current user access session 86a, and continues to monitor for additional network activity in step 40. As illustrated in step 92, the idle interval (illustrated in FIG. 4 by reference numeral 96) also can be identified based on whether the processor circuit 22 determines an absence of any user input to the user device 14, including any keystroke input, any speech input (e.g., speech to text translation), or any pointing device movement (e.g., mouse or touch pad) to the user device 14.

Hence, the processor circuit 22 continues to add network activity (e.g., “I4”) 42 to the first user access session (“P1”), illustrated in FIG. 4, until the processor circuit 22 detects in step 92 an idle interval 96. As illustrated in FIGS. 4 and 5, the network activity “I5” at time “T5” exceeds the idle interval 96 relative to the average input frequency (“F1”) 88 calculated in step 90 with respect to the inputs “I1”, “I2”, “I3”, and “I4”. Hence, the processor circuit 22 identifies the newest network activity “I5” as belonging to a new user access session 86b, and assigns in step 98 the newest network activity “I5” to a new user access session 86b, illustrated in FIG. 5A as having the session identifier “S2”.

After establishing a new user access session 98, the processor circuit 22 executes in step 100 a network usage pattern identification procedure call to detect the first pattern 78. As described previously, the first pattern (“P1”) 78 for the first user access session 86b has a determined frequency “F1” 88 that was determined instep 90 and that can be stored in the session information field 54 for each of the entries 46 associated with the first user access session 86a. The processor circuit 22 also can calculate and store in the data structure 48 for each of the entries 46 associated with the first user access session 86a the overall duration (D) 99 of the of the corresponding access session 86a.

Referring to FIG. 3C, the processor circuit 22 executes step 100 by assigning in step 102 a prescribed alias (e.g., “User 1”) 58 to identify the user having performed the first user access session 86a. As apparent from the foregoing, the alias 58 can be anonymous, and can be used solely to distinguish other users that may access the shared user devices 14. The processor circuit 22 determines in step 104 whether there are multiple stored patterns to determine whether merging of patterns by the same user can be performed. Since at this stage the processor circuit 22 has only determined the first pattern “P1” 78 for the first user access session 86a, the processor circuit 22 returns in step 106 to the method of FIG. 3A.

As apparent from the foregoing, the processor circuit 22 continues to add network activity entries 46 for the next user access session 86b in response to each detected network activity (e.g., “I5”, “I6”, “I7”, and “I8”) 42, until detecting with respect to the detected network activity “I9” another idle interval 96 in between the network activity of “I8” and “I9”. Hence, the network activity “I9” is detected relative to another user access session 86c initiated following the second user access session 86b and the second idle interval 96.

As described below, the user access sessions 86a and 86b can be considered part of a training interval 101 based on the processor circuit 22 determining with respect to FIG. 3B that the respective patterns “P1” and “P2” do not have a determined correlation, and therefore represent network activity by respective users (e.g., 16a and 16b).

As described previously, the processor circuit 22 can access the user identification procedure call in step 74 of FIG. 3A after each detected network activity 42. Referring to FIG. 3B, after the processor circuit 22 has stored more than two entries 46 in step 108 for the current user access session 86b, the processor circuit 22 can begin determining in step 110 whether the pattern of network usage “P2” 78 for the current session 86b matches a stored determined pattern “P1” 78 for a prior user access session (e.g., 86a). In particular, the processor circuit 22 can determine in step 112 whether there is a determined correlation between the patterns “P1” and “P2” as stored in the data structure 48. It will be apparent that numerous correlation techniques may be applied in order to determine whether there is a sufficient determined correlation between the patterns “P1” and “P2” of the respective user access sessions 86a and 86b. For example, with respect to the example 56a of recording the sequence of television channels that are watched, the first pattern “P1” 78 for the first user access session 86a includes the sequence of video provider identifiers “PBS”, “NBC”, “HGTV”, and “Travel” 62, whereas the second pattern “P2” 78 for the second user access session 86b includes the sequence of video provider identifiers “ESPN”, “Fox News”, “Discovery”, and “History”. Also note that other attributes can be applied between the patterns 78, including any correlation between the time of day, day of the week, or duration (D) 99 of the respective user access sessions 86a and 86b.

Hence, the processor circuit 22 can determine in step 112 that there is no correlation between the current pattern “P2” of the user access session 86b and the stored pattern “P1” of the user access session 86a. Consequently, the processor circuit 22 can classify in step 114 the current pattern “P2” 78 of the current user access session 86b as belonging to a new user by adding a new user alias “User 2” 58 to each of the network activity entries 58 associated with the second user access session 86b. The processor circuit then returns in step 116 to the method of FIG. 3.

Assume with respect to FIG. 4 that the processor circuit has completed updating the data structure 48 with the network activity entries 46 for the detected network activity “I9”, “I10”, and “I11” 42 associated with the third user access session 86c. Referring to the user identification procedure call of FIG. 3B, the processor circuit 22 can identify in step 112 that the network activity “I9”, “I10”, and “I11” 42 associated with the third user access session 86c and forming the third pattern “P3” 78 has a determined correlation with the first pattern “P1” established during the user access session 86a. As illustrated with respect to the first example 56a, the sequence of television channels that are watched for the first pattern “P1” 78 includes the sequence of video provider identifiers “PBS”, “NBC”, “HGTV”, and “Travel” 62, and the sequence of television channels for the third pattern “P3” 78 includes the sequence of video provider identifiers “PBS”, “NBC”, and “Travel”. In addition, the processor circuit 22 can determine that both the first pattern “P1” and the third pattern “P3” have a determined correlation with respect to time of day (e.g., within two minutes on subsequent days), and with respect to the duration 99 (e.g., approximately 8 minutes).

Hence, the processor circuit 22 can classify in step 120 the current pattern “P3” as having a determined correlation with the first storage pattern “P1”, indicating that the user access sessions 86a and 86c are performed by the same user (e.g., 16a). Hence, the processor circuit 22 can add in step 120 the alias 58 specified in the entries 46 for the first user session 86a (“User 1”) into the entries 46 for the third user session 86c. If desired, the processor circuit 22 also can append in step 122 the user identifier to a received request from the user device (e.g., 14b or 14c) prior to new request been forwarded by the apparatus 18 into the network 12 in step 80 of FIG. 3A. Hence, the processor circuit 22 can receive a request from a user device 14b or 14c in step 40 of FIG. 3A, append in step 122 of FIG. 3B the request with the user alias 58 identifying the user, and forward the request in step 80 with the user identifier 58 appended to the request to a prescribed destination, for example the media server 30 or the server 18′. Also note that the identification of the user 16a based on the matching patterns “P1” and “P3” can be completed even if the user 16 uses different user access devices during each user access session (e.g., device 14b for session 86a; device 14c for session 86c).

Hence, the processor circuit 22 can automatically identify users based on detected correlation between user input patterns, without the necessity of the user logging into a user access device. Further, a user can be identified even if the user employs different user access devices during different user access sessions. As apparent from FIGS. 5A and 5B, patterns can be detected and correlated from multiple traffic types, including television navigation, website navigation, or identifying network services that are used by a user during a given session. Regarding the example 56c, a correlation in the pattern can be determined based on identifying the collection of services that are in use during a given user access session 86, as opposed to the sequence of which the network services 70 are used. Hence, the correlation can be performed in example 56c with respect to multiple network services 70 that are concurrently provided to a user 16 via the user device 14.

Referring to FIG. 3C, after the processor circuit has identified the sessions 86a and 86c as completed by the same user (e.g., 16a), at the end of the session 86c (detected by the following idle interval 96) the processor circuit can identify step 124 that the stored patterns “P1” and “P3” have matching user identifiers or aliases 58, and therefore can update in step 126 be stored patterns P1 and P3 by merging together the patterns utilized by the same user (e.g., 16a). Hence, the pattern utilized by the same user 16 over successive user access sessions 86 can be updated to ensure accuracy based on changes in the user habits. In addition, the relative weighting of a recently-used pattern in updating a stored pattern can be adjusted based on the number of user inputs to the same destination, such that a new website visited by the user can be “ignored” (and therefore not added to the stored pattern) until a prescribed minimum number of visits to the website has been detected.

As described previously, the identification of a user can be helpful in providing recommendations to a destination server within the network 12. The identification of the user (e.g., by alias identifier) can be appended to a received HTTP request, as described above with respect to step 122 of FIG. 3B.

Referring to FIG. 3D, the processor circuit 22 also can be configured for responding to a query from the network server 18′ or 30. In particular, in response to the apparatus 18 receiving in step 130 a query from a network server (e.g., based on forwarding a request without the user identifier to the network server), the processor circuit 22 can selectively respond to the query by supplying to the destination server 30 providing the network service the user identifier 58 in step 134 if the processor circuit 22 determines in step 132 that the user can be identified. If the user cannot be identified, the processor circuit 22 can send in step 136 a response at the user currently is not identifiable.

According to example embodiments, users of shared user devices at a user premises can be distinguished based on identifying patterns of network usage from network activity detected during distinct user access sessions following a training interval 101, illustrated in FIG. 4. Hence, subsequent user sessions 86 during a recognition time interval 142 enables the processor circuit 22 to automatically identify users based on detected patterns. Training intervals may be repeated or updated periodically in order to identify changes in user behavior over time that affect the corresponding pattern of network usage by the user.

While the example embodiments in the present disclosure have been described in connection with what is presently considered to be the best mode for carrying out the subject matter specified in the appended claims, it is to be understood that the example embodiments are only illustrative, and are not to restrict the subject matter specified in the appended claims.

What is claimed is:

1. A method comprising:
detecting, by an apparatus, first network activity within a time interval on at least a first user device at a user premises, the first user device usable by at least first and second users and distinct from the apparatus, the apparatus positioned at the user premises;
determining by the apparatus from the first network activity a first pattern of network usage associated with the first user and a second pattern of network usage associated with the second user, the second pattern distinct from the first pattern;
detecting, by the apparatus, second network activity on the first user device at the user premises following the time interval; and
selectively identifying by the apparatus the second network activity as performed by the first user based on a determined correlation between the second network activity and the first pattern of network usage.

2. The method of claim 1, wherein the determining includes:
first determining the first network activity includes at least one of video navigation selection commands from the first user device, or addressable video streams presented at the user premises in response to the video navigation selection commands,
second determining the first pattern as a first identifiable sequence of at least a first subset of the addressable video streams, and
third determining the second pattern as a second identifiable sequence of at least a second subset of the addressable video streams.

3. The method of claim 2, wherein:
the selectively identifying includes determining the second network activity includes at least one of second video navigation selection commands from the first user device, at least a third subset of the addressable video streams presented in response to the second video navigation selection commands, or second addressable video streams presented at the user premises in response to the second video navigation selection commands;
the method further comprising identifying each of the addressable video streams presented at the user premises by at least one of a video provider identifier specifying a video provider supplying the corresponding addressable video stream, metadata describing the corresponding addressable video stream, or a channel guide identifier identifying the addressable video stream as a prescribed video channel guide.

4. The method of claim 1, wherein the determining includes:
first determining the first network activity as including hypertext transport protocol (HTTP) requests specifying respective first destination websites reachable by the apparatus via an Internet Protocol (IP) based wide area network,
second determining the first pattern as a first identifiable sequence of at least a first subset of the HTTP requests, and
third determining the second pattern as a second identifiable sequence of at least a second subset of the HTTP requests;
wherein the selectively identifying includes determining the second network activity includes at least a third subset of the HTTP requests.

5. The method of claim 1, further comprising identifying first and second portions of the time interval based on:
detecting the first pattern from the first user device having a first determined input frequency followed by a first detected idle interval; and
detecting the second pattern from the first user device following the determined idle interval and having a second determined input frequency followed by a second detected idle interval;
the first portion identified as containing the first pattern occurring before the first detected idle interval and the second portion identified as between the first detected idle interval and second detected idle interval.

6. The method of claim 5, wherein the first and second idle intervals are identified based on a determined absence of any user input to the first user device, including any keystroke input, speech input, or pointing device movement to the first user device.

7. The method of claim 1, wherein the selectively identifying includes determining the correlation between the first pattern of network usage and a determined third pattern of network usage within the second network activity.

8. The method of claim 7, wherein:
the detecting of the second network activity is detected relative to a second time interval following the first time interval;
the selectively identifying including determining a second correlation between a first portion of the time interval and the second time interval, the first pattern of network usage associated with the first user within the first portion of the time interval and the second pattern of network usage associated with the second user within a second portion of the time interval, the second correlation relative to at least one of a time of day, a day of week, or a duration of the first pattern relative to a duration of the third pattern.

9. The method of claim 1, further comprising the apparatus supplying the identification of the second network activity as performed by the first user based on at least one of:
the apparatus receiving a request, from the first user device during the second network activity, for a network service reachable by the apparatus, appending to the request a user identifier, and forwarding the request with the user identifier to the network service; or
the apparatus receiving the request and forwarding the request without the user identifier to the network service, a receiving a query from the network service, and the apparatus responding to the query by supplying to the network service the user identifier.

10. The method of claim 1, wherein the determining includes:
first determining the first network activity includes an identifiable group of network services requested by the first user device and reachable by the apparatus, each network service having a corresponding transport layer port identifier,
second determining the first pattern as a first identified subset of the identifiable group, and
third determining the second pattern as a second identified subset of the identifiable group;
wherein the selectively identifying includes determining the second network activity as including at least a third subset of the network services.

11. The method of claim 1, further comprising generating an updated first pattern of network usage associated with the first user based on merging the first pattern of network usage with the second network activity in response to identifying a second network activity as performed by the first user.

12. An apparatus comprising:
a device interface circuit configured for detecting first network activity within a time interval on at least a first user device at a user premises, the first user device usable by at least first and second users and distinct from the apparatus, the apparatus positioned at the user premises; and
a processor circuit configured for determining from the first network activity a first pattern of network usage associated with the first user and a second pattern of network usage associated with the second user, the second pattern distinct from the first pattern;
the device interface circuit further configured for detecting second network activity on the first user device at the user premises following the time interval;
the processor circuit further configured for selectively identifying the second network activity as performed by the first user based on a determined correlation between the second network activity and the first pattern of network usage.

13. The apparatus of claim 12, wherein:
the first network activity is determined by the processor circuit as including at least one of video navigation selection commands from the user device, or addressable video streams presented at the user premises in response to the video navigation selection commands;
the processor circuit configured for determining the first pattern as a first identifiable sequence of at least a first subset of the addressable video streams, and the second pattern as a second identifiable sequence of at least a second subset of the addressable video streams.

14. The apparatus of claim 13, wherein the processor circuit is configured for:
determining the second network activity as including at least one of second video navigation selection commands from the first user device, at least a third subset of the addressable video streams presented in response to the second video navigation selection commands, or second addressable video streams presented at the user premises in response to the second video navigation selection commands; and
identifying each of the addressable video streams presented at the user premises by at least one of a video provider identifier specifying a video provider supplying the corresponding addressable video stream, metadata describing the corresponding addressable video stream, or a channel guide identifier identifying the addressable video stream as a prescribed video channel guide.

15. The apparatus of claim 12, wherein:
the first network activity is determined by the processor circuit as including hypertext transport protocol (HTTP) requests specifying respective first destination websites reachable by the apparatus via an Internet Protocol (IP) based wide area network;
the processor circuit configured for determining the first pattern as a first identifiable sequence of at least a first subset of the HTTP requests, and the second pattern as a second identifiable sequence of at least a second subset of the HTTP requests;
the second network activity detected by the processor circuit as including at least a third subset of the HTTP requests.

16. The apparatus of claim 12, wherein the processor circuit is configured for identifying first and second portions of the time interval based on:
detecting the first pattern from the first user device having a first determined input frequency followed by a first detected idle interval; and
detecting the second pattern from the first user device following the determined idle interval and having a second determined input frequency followed by a second detected idle interval;
the first portion identified by the processor circuit as containing the first pattern occurring before the first detected idle interval and the second portion identified by the processor circuit as between the first detected idle interval and second detected idle interval.

17. The apparatus of claim 16, wherein the processor circuit is configured for identifying the first and second idle intervals based on a determined absence of any user input to the first user device, including any keystroke input, speech input, or pointing device movement to the first user device.

18. The apparatus of claim 12, wherein the processor circuit is configured for determining the correlation between the first pattern of network usage and a determined third pattern of network usage within the second network activity.

19. The apparatus of claim 18, wherein the processor circuit is configured for:
detecting the second network activity relative to a second time interval following the first time interval; and
determining a second correlation between a first portion of the time interval and the second time interval, the first pattern of network usage associated with the first user within the first portion of the time interval and the second pattern of network usage associated with the second user within a second portion of the time interval, the second correlation relative to at least one of a time of day, a day of week, or a duration of the first pattern relative to a duration of the third pattern.

20. The apparatus of claim 12, wherein the processor circuit is configured for supplying the identification of the second network activity as performed by the first user based on at least one of:
the processor circuit determining a request, received by the device interface circuit from the first user device during the second network activity, for a network service reachable by the apparatus, the processor circuit appending to the request a user identifier, and the device interface circuit forwarding the request with the user identifier to the network service; or
the device interface circuit receiving the request and forwarding the request without the user identifier to the network service, the device interface circuit receiving a query from the network service, and the processor circuit responding to the query by supplying to the network service the user identifier.

21. The apparatus of claim 12, wherein:
the first network activity is determined by the processor circuit as including an identifiable group of network services requested by the first user device and reachable by the apparatus, each network service having a corresponding transport layer port identifier;
the processor circuit configured for determining the first pattern as a first identified subset of the identifiable group, and determining the second pattern as a second identified subset of the identifiable group;
the second network activity determined by the processor circuit as including at least a third subset of the network services.

22. The apparatus of claim 12, wherein the processor circuit is configured for generating an updated first pattern of network usage associated with the first user based on merging the first pattern of network usage with the second network activity in response to identifying a second network activity as performed by the first user.

23. An apparatus comprising:
a device interface circuit configured for detecting first network activity within a time interval on at least a first user device at a user premises, the first user device usable by at least first and second users and distinct from the apparatus, the apparatus positioned at the user premises; and
means for determining from the first network activity a first pattern of network usage associated with the first user and a second pattern of network usage associated with the second user, the second pattern distinct from the first pattern;
the device interface circuit further configured for detecting second network activity on the first user device at the user premises following the time interval;
the means for determining further configured for selectively identifying the second network activity as performed by the first user based on a determined correlation between the second network activity and the first pattern of network usage.

24. Logic encoded in one or more tangible media for execution and when executed operable for:
detecting, by an apparatus executing the logic, first network activity within a time interval on at least a first user device at a user premises, the first user device usable by at least first and second users and distinct from the apparatus, the apparatus positioned at the user premises;
determining by the apparatus from the first network activity a first pattern of network usage associated with the first user and a second pattern of network usage associated with the second user, the second pattern distinct from the first pattern;
detecting, by the apparatus, second network activity on the first user device at the user premises following the time interval; and
selectively identifying by the apparatus the second network activity as performed by the first user based on a determined correlation between the second network activity and the first pattern of network usage.

25. A method comprising:
detecting, by an apparatus, first network activity within a time interval on at least a first user device at a user premises, the first user device usable by at least first and second users and distinct from the apparatus, the apparatus positioned at the user premises;
determining by the apparatus from the first network activity a first pattern of network usage associated with the first user and a second pattern of network usage associated with the second user, the second pattern distinct from the first pattern;
detecting, by the apparatus, second network activity on a second user device at the user premises following the time interval; and
selectively identifying by the apparatus the second network activity as performed by the first user based on a determined correlation between the second network activity and the first pattern of network usage.

26. An apparatus comprising:
a device interface circuit configured for detecting first network activity within a time interval on at least a first user device at a user premises, the first user device usable by at least first and second users and distinct from the apparatus, the apparatus positioned at the user premises; and
a processor circuit configured for determining from the first network activity a first pattern of network usage associated with the first user and a second pattern of network usage associated with the second user, the second pattern distinct from the first pattern;
the device interface circuit further configured for detecting second network activity on a second user device at the user premises following the time interval;
the processor circuit further configured for selectively identifying the second network activity as performed by the first user based on a determined correlation between the second network activity and the first pattern of network usage.
